(19) United States
(12) Patent Application Publication
(10) Pub. No.: US 2024/0062408 A1
(43) Pub. Date: Feb. 22, 2024

(54) METHOD, DEVICE, AND NON-TRANSITORY COMPUTER-READABLE RECORDING MEDIUM FOR ANALYZING VISITOR ON BASIS OF IMAGE IN EDGE COMPUTING ENVIRONMENT

(71) Applicant: MAY-I INC., Seoul (KR)

(72) Inventors: Jin Woo PARK, Incheon (KR); In Sik SHIN, Seoul (KR)

(73) Assignee: MAY-I INC., Seoul (KR)

(21) Appl. No.: 18/270,408

(22) PCT Filed: Nov. 15, 2021
(86) PCT No.: PCT/KR2021/016654

§ 371 Date: Oct. 3, 2023

(30) Foreign Application Priority Data
Dec. 31, 2020 (KR) 10-2020-0188854

(51) Int. Cl. G06T 7/70; G06V 20/52; G06T 7/20; G06V 10/25; G06V 10/44; G06V 10/771

(52) U.S. Cl. CPC G06T 7/70; G06V 20/52; G06T 7/20; G06V 10/25; G06V 10/44; G06V 10/771; G06V 2201/07; G06T 2207/20084

(57) ABSTRACT

A method for analyzing a visitor on the basis of a video in an edge computing environment is provided. The method includes the steps of: extracting feature data from a captured video of an offline space; generating detection data on a location and an appearance of an object contained in the captured video from the feature data using an artificial neural network-based detection model; and integrating detection data of a location and an appearance of a target object.

### CROSS-REFERENCE TO RELATED APPLICATION(S)

This application is a national phase of Patent Cooperation Treaty (PCT) International Application No. PCT/KR2021/016654 filed on Nov. 15, 2021, which claims priority to Korean Patent Application No. 10-2020-0188854 filed on Dec. 31, 2020. The entire contents of PCT International Application No. PCT/KR2021/016654 and Korean Patent Application No. 10-2020-0188854 are hereby incorporated by reference.

### FIELD OF THE INVENTION

The present invention relates to a method, device, and non-transitory computer-readable recording medium for analyzing a visitor on the basis of a video in an edge computing environment.

### BACKGROUND

As the technology in the field of computer vision has rapidly advanced in recent years, various techniques have been introduced to detect and recognize objects in a video and identify meaningful information therefrom.

In particular, there is a growing demand for techniques for analyzing a video captured in an offline space to collect information on the number, genders, ages, and the like of people visiting the space, and assisting in utilizing the information to establish marketing or sales strategies.

As an example of related conventional techniques, a technique has been introduced to count the number of visitors to an offline store using sensors such as cameras installed around the entrance/exit of the offline store. However, according to the conventional technique, it is difficult to determine demographic information required to establish marketing strategies (e.g., genders and ages of the visitors).

As another example of the conventional techniques, a technique has been introduced to identify demographic information of visitors by building a system for recognizing appearances (e.g., faces) of the visitors separately from a system for counting the number of the visitors. However, according to the conventional technique, there is a problem that it is difficult to integrate and utilize information on the number of the visitors and the demographic information of the visitors, which are respectively derived from the two systems built separately, and there is a limitation that storing, transmitting, or processing a video capturing the appearances (e.g., faces) of the visitors may cause a risk of legal issues related to privacy protection, because the video includes sensitive personal information.

In this connection, the inventor(s) present a technique capable of increasing efficiency in terms of computing speed and resource utilization in analyzing visitors to an offline space, and reducing a risk of legal issues related to privacy protection, by causing a client-side device in an edge computing environment to integratively generate a variety of data on locations and appearances of visitors contained in a video captured in the offline space.

### SUMMARY OF THE INVENTION

One object of the present invention is to solve all the above-described problems in prior art.

Another object of the invention is to integratively generate a variety of data on entry/exit information and demographic information of a visitor contained in a video captured in an offline space, by extracting feature data from a captured video of an offline space, generating detection data on a location and an appearance of an object contained in the captured video from the feature data using an artificial neural network-based detection model, and integrating detection data on a location and an appearance of a target object.

Yet another object of the invention is to generate integrated detection data on a location and an appearance of a visitor using a light-weighted detection model in an edge computing device rather than a server, thereby saving time required for communication between the device and the server or advanced analysis in the server, and promptly identifying entry/exit information and demographic information of visitors on site (i.e., in an offline space) where the edge computing device is installed.

Still another object of the invention is to generate detection data on a visitor using only resources of an edge computing device, without transmitting a video capturing the visitor to an external server, thereby reducing a risk of legal issues related to privacy protection of the visitor contained in the video.

The representative configurations of the invention to achieve the above objects are described below.

According to one aspect of the invention, there is provided a method for analyzing a visitor on the basis of a video in an edge computing environment, the method comprising the steps of: extracting feature data from a captured video of an offline space; generating detection data on a location and an appearance of an object contained in the captured video from the feature data using an artificial neural network-based detection model; and integrating detection data on a location and an appearance of a target object.

According to another aspect of the invention, there is provided a device for analyzing a visitor on the basis of a video in an edge computing environment, the device comprising: a feature extraction unit configured to extract feature data from a captured video of an offline space; an information detection unit configured to generate detection data on a location and an appearance of an object contained in the captured video from the feature data using an artificial neural network-based detection model; and a data integration unit configured to integrate detection data on a location and an appearance of a target object.

In addition, there are further provided other methods and devices to implement the invention, as well as non-transitory computer-readable recording media having stored thereon computer programs for executing the methods.

According to the invention, it is possible to integratively generate a variety of data on entry/exit information and demographic information of a visitor contained in a video captured in an offline space.

According to the invention, it is possible to save time required for communication between a device and a server or advanced analysis in the server, and promptly identify entry/exit information and demographic information of visitors on site (i.e., in an offline space) where an edge computing device is installed.

According to the invention, it is possible to reduce a risk of legal issues related to privacy protection of a visitor contained in a captured video.

### BRIEF DESCRIPTION OF THE DRAWINGS

FIG. 1 schematically shows the configuration of an entire system for analyzing a visitor on the basis of a video in an edge computing environment according to one embodiment of the invention.

FIG. 2 specifically shows the internal configuration of a device according to one embodiment of the invention.

FIG. 3 specifically shows the internal configuration of an object recognition management unit according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Configuration of the Entire System

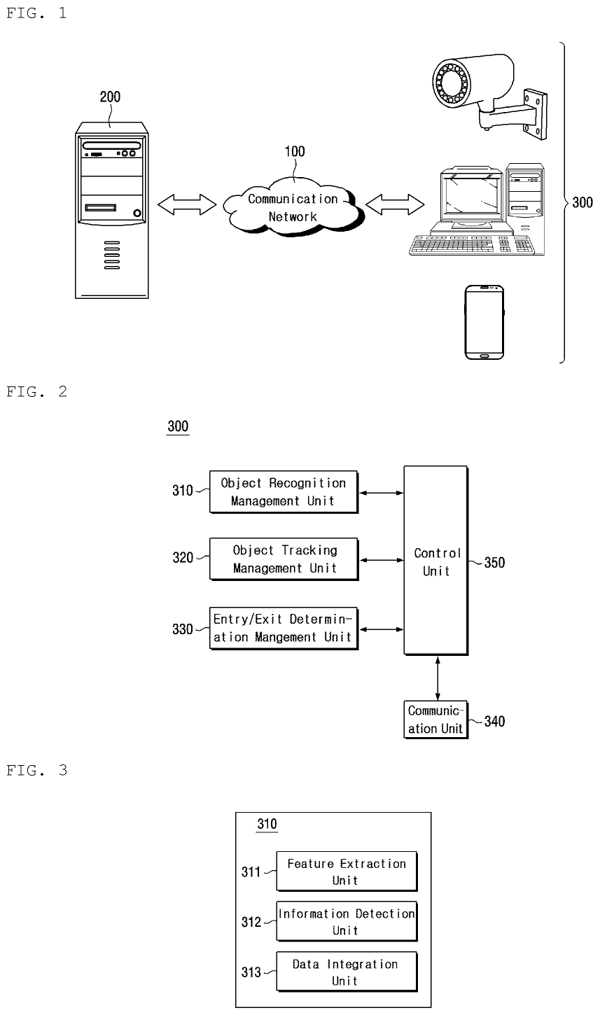

FIG. 1 schematically shows the configuration of the entire system for analyzing a visitor on the basis of a video in an edge computing environment according to one embodiment of the invention.

As shown in FIG. 1, the entire system according to one embodiment of the invention may comprise a communication network 100, a server 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the server 200 according to one embodiment of the invention is equipment capable of communicating with the device 300 to be described below via the communication network 100, and may function to acquire a variety of data transmitted from the device 300 and transmit a variety of data required for operation of the device 300 to the device 300.

Next, the device 300 according to one embodiment of the invention is digital equipment capable of communicating with the server 200 or another system (not shown) via the communication network 100, and may function to integratively generate a variety of data on entry/exit information and demographic information of a visitor contained in a video captured in an offline space, by extracting feature data from a captured video of an offline space, generating detection data on a location and an appearance of an object contained in the captured video from the feature data using an artificial neural network-based detection model, and integrating detection data on a location and an appearance of a target object.

The configuration and functions of the device 300 according to the invention will be discussed in more detail below.

Meanwhile, any type of digital equipment having a memory means and a microprocessor for computing capabilities may be adopted as the device 300 according to the invention. Further, the device 300 according to one embodiment of the invention may refer to a device capable of capturing a video (e.g., a commercial security camera or an IP camera) itself, but may also encompass a device capable of being connected (or coupled) thereto in a wired and/or wireless manner (e.g., a smart phone, a tablet, or a PC).

Meanwhile, the device 300 according to the invention may include an application (not shown) for supporting the functions according to the invention. The application may be downloaded from an external application distribution server (not shown). Here, at least a part of the application may be replaced with a hardware device or a firmware device that may perform a substantially equal or equivalent function, as necessary.

Configuration of the Device

Hereinafter, the internal configuration of the device 300 crucial for implementing the invention and the functions of the respective components thereof will be discussed.

FIG. 2 specifically shows the internal configuration of the device 300 according to one embodiment of the invention.

As shown in FIG. 2, the device 300 according to one embodiment of the invention may comprise an object recognition management unit 310, an object tracking management unit 320, an entry/exit determination management unit 330, a communication unit 340, and a control unit 350. According to one embodiment of the invention, at least some of the object recognition management unit 310, the object tracking management unit 320, the entry/exit determination management unit 330, the communication unit 340, and the control unit 350 may be program modules to communicate with an external system (not shown). The program modules may be included in the device 300 in the form of operating systems, application program modules, or other program modules, while they may be physically stored in a variety of commonly known storage devices. Further, the program modules may also be stored in a remote storage device that may communicate with the device 300. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the device 300 has been described as above, and it will be apparent to those skilled in the art that at least a part of the components or functions of the device 300 may be implemented or included in the server 200 or an external system (not shown), as necessary.

First, the object recognition management unit 310 according to one embodiment of the invention may function to generate integrated detection data on a location and an appearance of an object (primarily a visitor) contained in a video captured in an offline space (e.g., a store, office, school, performance venue, or stadium). Specifically, the object recognition management unit 310 according to one embodiment of the invention may analyze the captured video to count the number of visitors entering and exiting from the offline space and estimate demographic information of the visitors (i.e., information that may be estimated from appearances of the visitors). Further, the object recognition management unit 310 according to one embodiment of the invention may utilize computing resources of an auxiliary operational device (not shown), which is provided separately from the device 300 according to the invention, in order to perform the analysis using an artificial neural network-based model that requires a significant amount of operations.

Here, according to one embodiment of the invention, the captured video to be analyzed may be collected from a separate video capture device (e.g., a commercial security camera or an IP camera) installed in the offline space, or from a video capture module provided in the device 300 according to the invention. Further, according to one embodiment of the invention, the captured video collected as above may be sampled at a predetermined interval (e.g., 10 fps) or sampled when a motion (or a difference between adjacent frames) found in the captured video is at or above a predetermined level, and the captured video sampled as above may be delivered to the object recognition management unit 310.

More specifically, the object recognition management unit 310 according to one embodiment of the invention may comprise a feature extraction unit 311, an information detection unit 312, and a data integration unit 313.

First, the feature extraction unit 311 according to one embodiment of the invention may function to extract feature data from a captured video of an offline space.

Specifically, the feature extraction unit 311 according to one embodiment of the invention may receive arbitrarily-sized frames constituting the captured video and output feature data in the form of a tensor. Further, the feature extraction unit 311 according to one embodiment of the invention may use an artificial neural network (primarily a deep neural network) based model as a means for extracting the feature data from the captured video. For example, the artificial neural network may be implemented on the basis of a well-known structure such as deep layer aggregation (DLA) or a residual neural network (ResNet).

Next, the information detection unit 312 according to one embodiment of the invention may function to generate detection data on a location and an appearance of an object contained in the captured video from the feature data using an artificial neural network-based detection model.

Here, according to one embodiment of the invention, the detection data on the location of the object may include detection data on an objectness score of a bounding box corresponding to the object (i.e., a score for likelihood that the bounding box corresponds to a real object) and a width, height, center offset, and the like of the bounding box, and may include detection data on a location of a foot of the object.

Further, according to one embodiment of the invention, the detection data on the appearance of the object may include detection data on demographic information (e.g., an age and gender of a visitor) that may be detected from the appearance of the object and usefully employed for marketing. According to one embodiment of the invention, the detection data on the age, gender, and the like of the object may be anonymized.

Further, according to one embodiment of the invention, the artificial neural network-based detection model may be trained to detect a certain attribute of the visitor from the feature data, and may be implemented on the basis of an artificial neural network such as a fully convolutional network (FCN). Furthermore, according to one embodiment of the invention, the detection data generated as a result of the artificial neural network-based detection model analyzing the feature data may be generated on the basis of a feature map, so that a plurality of pieces of feature data on different attributes may be associated with each other via the feature map (or coordinate points on the feature map).

Specifically, the information detection unit 312 according to one embodiment of the invention may generate the detection data on the location and appearance of the object using two or more artificial neural network-based detection models. For example, the artificial neural network-based detection models may include a first detection model for generating a part of the detection data on the location and appearance of the object, and a second detection model for generating the remaining part of the detection data on the location and appearance of the object.

Further, the artificial neural network-based detection models used by the information detection unit 312 according to one embodiment of the invention may be separated from or integrated with each other, as necessary or depending on what attributes are to be detected.

For example, the artificial neural network-based detection models used by the information detection unit 312 according to one embodiment of the invention may include a detection model for generating detection data on one of multiple attributes of the object (e.g., an objectness score, width, height, and center offset of a bounding box corresponding to the object, a location of a foot of the object, and a gender and age of the object) on the basis of a single feature map.

As another example, the artificial neural network-based detection models used by the information detection unit 312 according to one embodiment of the invention may include a detection model for generating detection data on two or more of multiple attributes of the object (e.g., an objectness score, width, height, and center offset of a bounding box corresponding to the object, a location of a foot of the object, and a gender and age of the object) together on the basis of a single feature map.

Next, when the detection data is generated as above, the data integration unit 313 according to one embodiment of the invention may function to integrate detection data on a location and an appearance of a target object.

Specifically, the data integration unit 313 according to one embodiment of the invention may integrate the detection data on the location and appearance of the target object by assigning at least a part of the detection data on the location and appearance of the target object to the target object, via at least one coordinate point on a feature map on which the detection data is based.

For example, when an objectness score of a bounding box corresponding to the target object is at or above a predetermined level, and the bounding box is located at a first coordinate point on a feature map, the data integration unit 313 according to one embodiment of the invention may determine that the target object is located at the first coordinate point on the feature map. Accordingly, the data integration unit 313 according to one embodiment of the invention may assign a pixel value corresponding to the first coordinate point to the target object on each feature map on which the detection data on the location and appearance of the target object is based, via the first coordinate point on the feature map. Here, the pixel value that may be assigned to the target object may include a length of a width of the bounding box, a length of a height of the bounding box, a location of a center offset of the bounding box, a location of a foot of the target object, a gender of the target object (e.g., a value between 0 and 1), an age of the target object (e.g., a score vector by class), and the like.

Although the artificial neural network technique that may be employed in the invention has been described as above, it is noted that the artificial neural network technique that may be employed in the invention is not necessarily limited to the foregoing, and may be changed or expanded without limitation as long as the objects of the invention may be achieved. For example, an artificial neural network technique such as R-CNN (Region-based Convolutional Neural Network), YOLO (You Only Look Once), and SSD (Single Shot Detector) may be used to extract the feature data or generate the detection data.

Further, the artificial neural network-based extraction model or detection model that may be employed in the invention may be light-weighted by a light-weighting algorithm such as pruning, quantization, or knowledge distillation, so that it may operate smoothly even on the device 300 having relatively insufficient computing resources in an edge computing environment, and the light-weighted model may be generated in the server 200 or an external system (not shown) and distributed to the device 300. However, it is noted that the light-weighting algorithm according to one embodiment of the invention is not limited to those listed above, and may be diversely changed as long as the objects of the invention may be achieved.

Next, the object tracking management unit 320 according to one embodiment of the invention may function to track the target object with reference to the detection data integratively generated by the object recognition management unit 310.

Specifically, the object tracking management unit 320 may manage a tracklet with respect to each frame of the captured video, and may associate an existing tracklet with or create a new tracklet for the target object detected in a new frame. For example, the object tracking management unit 320 according to one embodiment of the invention may determine whether to associate an existing tracklet with or create a new tracklet for the target object on the basis of a degree of overlap between a bounding box predicted for the target object and an actually inputted bounding box (e.g., on the basis of Intersection over Union (IoU)) with respect to each frame.

Further, the object tracking management unit 320 according to one embodiment of the invention may assign the detection data of the target object (e.g., detection data on a bounding box corresponding to the target object, a foot location of the target object, and a gender and age of the target object) generated by the object recognition management unit 310 to the tracklet corresponding to the target object.

However, it is noted that the object tracking algorithm according to one embodiment of the invention is not limited to those listed above, and may be diversely changed as long as the objects of the invention may be achieved.

Next, the entry/exit determination management unit 330 according to one embodiment of the invention may function to determine whether the target object enters or exits from the offline space by determining whether the target object passes a predetermined detection line with reference to information on the tracking of the target object (i.e., information on the tracklet) generated by the object tracking management unit 320.

Specifically, the entry/exit determination management unit 330 according to one embodiment of the invention may set a vector having an initial point at a foot location of the target object specified by a tracklet in a previous frame, and a terminal point at a foot location of the target object specified by a tracklet in a current frame, and may determine that the target object passes a detection line set near an entry/exit, when an intersection point exists between the vector set as above and the detection line. Further, the entry/exit determination management unit 330 according to one embodiment of the invention may determine whether the target object enters the offline space (e.g., a store) or exits from the offline space with reference to information on a direction of the vector and information on a direction of entry relative to the detection line.

However, it is noted that the entry/exit determination algorithm according to one embodiment of the invention is not limited to those listed above, and may be diversely changed as long as the objects of the invention may be achieved.

Meanwhile, the device 300 according to one embodiment of the invention may integrate all of the detection data integratively generated in the process of recognizing the target object, the data on the tracklet generated in the process of tracking the target object, and the data on the entry or exit of the target object generated in the process of determining the entry/exit of the target object, and may transmit the integrated data to the server 200 or an external system.

Next, the communication unit 340 according to one embodiment of the invention may function to enable data transmission/reception from/to the object recognition management unit 310, the object tracking management unit 320, and the entry/exit determination management unit 330.

Lastly, the control unit 350 according to one embodiment of the invention may function to control data flow among the object recognition management unit 310, the object tracking management unit 320, the entry/exit determination management unit 330, and the communication unit 340. That is, the control unit 350 according to the invention may control data flow into/out of the device 300 or data flow among the respective components of the device 300, such that the object recognition management unit 310, the object tracking management unit 320, the entry/exit determination management unit 330, and the communication unit 340 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for analyzing a visitor on the basis of a video in an edge computing environment, the method comprising the steps of:
extracting feature data from a captured video of an offline space;
generating detection data on a location and an appearance of an object contained in the captured video from the feature data using an artificial neural network-based detection model; and
integrating detection data on a location and an appearance of a target object.

2. The method of claim 1, wherein the detection data is generated on the basis of a feature map.

3. The method of claim 1, wherein the detection data on the location of the object includes detection data on at least one of an objectness score, width, height, and center offset of a bounding box corresponding to the object, and detection data on a location of a foot of the object, and
wherein the detection data on the appearance of the object includes detection data on at least one of an age and gender of the object.

4. The method of claim 1, wherein the detection model includes a first detection model for generating a part of the detection data on the location and appearance of the object, and a second detection model for generating the remaining part of the detection data on the location and appearance of the object.

5. The method of claim 1, wherein the detection model includes a detection model for generating detection data on one of a plurality of attributes related to the location and appearance of the object on the basis of a single feature map.

6. The method of claim 1, wherein the detection model includes a detection model for generating detection data on two or more of a plurality of attributes related to the location and appearance of the object on the basis of a single feature map.

7. The method of claim 1, wherein in the integrating step, the detection data on the location and appearance of the target object is integrated by assigning at least a part of the detection data on the location and appearance of the target object to the target object, via at least one coordinate point on a feature map on which the generated detection data is based.

8. The method of claim 1, further comprising the step of tracking the target object in the captured video with reference to the detection data on the location of the target object.

9. The method of claim 8, further comprising the step of determining entry or exit of the target object by determining whether the target object passes a predetermined detection line with reference to information on the tracking.

10. A non-transitory computer-readable recording medium having stored thereon a computer program for executing the method of claim 1.

11. A device for analyzing a visitor on the basis of a video in an edge computing environment, the device comprising:
a feature extraction unit configured to extract feature data from a captured video of an offline space;
an information detection unit configured to generate detection data on a location and an appearance of an object contained in the captured video from the feature data using an artificial neural network-based detection model; and
a data integration unit configured to integrate detection data on a location and an appearance of a target object.
